(19) United States
(12) Patent Application Publication
(10) Pub. No.: US 2013/0122797 A1
(43) Pub. Date: May 16, 2013

(54) AIR OUTLET DEVICE

(71) Applicant: GM GLOBAL TECHNOLOGY OPERATIONS LLC, Detroit, MI (US)

(72) Inventors: Peter Arndt, Ruesselsheim (DE); Udo Rothmeier, Bischofsheim (DE)

(73) Assignee: GM GLOBAL TECHNOLOGY OPERATIONS LLC, Detroit, MI (US)

(21) Appl. No.: 13/670,509

(22) Filed: Nov. 7, 2012

(30) Foreign Application Priority Data
Nov. 10, 2011 (DE) 10 2011 118 148.6

(51) Int. Cl. B60H 1/34

(52) U.S. Cl. CPC B60H 1/34
USPC 454/145

(57) ABSTRACT

An air outlet device for the interior of a motor vehicle is provided. The air outlet device includes a housing that exhibits an outflow surface, and at least one pivoting flap integrated in a wall of the housing upstream from the outflow surface.

### CROSS-REFERENCE TO RELATED APPLICATION

This application claims priority to German Patent Application No. 10 2011 118 148.6, filed Nov. 10, 2011, which is incorporated herein by reference in its entirety.

### TECHNICAL FIELD

The present disclosure relates to an air outlet device for a ventilator of a motor vehicle, which is designed in particular to regulate and influence a stream of air entering the passenger compartment of the motor vehicle.

### BACKGROUND

Air outlet devices or air vents are sufficiently known for the interior of motor vehicles. One or more air outlet devices generally recessed in the dashboard of a motor vehicle allow the passengers in the motor vehicle to individually change both the quantity of air and the direction in which the air entering the passenger compartment flows. Even though the inflowing quantity of air can be varied with a ventilator fan, the air outlet device can also be used to alter the very flow characteristics of the stream of air entering the passenger compartment.

For example, air outlet devices can exhibit several lamellae, with which the air stream generated by the fan can be steered in different directions. However, passengers want to be able to individually regulate not just the direction, but also the intensity or flow rate of the air stream on the air outlet device at a prescribed fan power level, in particular under extreme climatic conditions. Against this backdrop, it is desirable to diminish the freely traversable cross section of the air outlet device, for example to increase the flow rate of the supplied air, as well as to bring about a bundled or spatially focused inflow.

For example, DE 197 39 652 A1 discloses a ventilator with a housing that exhibits an outflow region, and incorporates an air deflector device and flow restrictor. The flow restrictor here exhibits two restrictor elements that can move relative to each other, wherein an outlet cross section can be varied without changing the direction of flow of the exiting air by moving the restrictor elements relative to each other.

Accordingly, it may be desirable to provide an improved air outlet device. In addition, other objects, desirable features and characteristics will become apparent from the subsequent summary and detailed description, and the appended claims, taken in conjunction with the accompanying drawings and this background.

### SUMMARY

In one exemplary embodiment of the present disclosure, provided is an air outlet device that allows the user to specifically and controllably adjust the flow characteristics, in one example, the spatial bundling or expansion of the air stream. In addition, the air outlet device is intended to achieve a reduction in weight, and exhibit a design that is as simple and cost-effective to implement as possible.

The air outlet device provided in this regard is intended for the interior of a motor vehicle. It exhibits a housing with an outlet surface. The housing provides a flow channel for the stream of air exiting via the outlet surface, and can be connected in terms of flow with the fan of a ventilator in a motor vehicle. The outlet surface of the air outlet device can typically be integrated into the interior lining of the motor vehicle, in one example, into the dashboard.

Upstream from the outlet surface, the air outlet device exhibits at least one pivoting flap integrated into a housing wall. This at least one flap generally has a dual function. On the one hand, it can specifically change the flow cross section of the housing to alter the flow characteristics of the air flow. On the other hand, the flap can also offer a locking function for the air outlet device, and thereby close off the entire flow cross section of the housing.

In this regard, the flap can act as both a locking flap and restrictor flap. By recessing or integrating the flap itself into the housing wall, it can be configured as part of the housing wall, thereby enabling a corresponding design of the air outlet device that saves on both space and weight.

In one exemplary embodiment, the flap can seal an opening formed in the housing wall in an open position. In other words, the housing wall accommodating the flap can exhibit an opening that corresponds to the geometric configuration and expansion of the pivoted flap. As a consequence, the flap comprises an integral component of the housing wall, at least when in the open position. It is integrated largely flush in the latter in the open position, wherein an open position in this case refers to a flap configuration in which the flap releases the cross section of the housing traversable by air in terms of flow, and only imperceptibly constricts it, if at all.

When the flap pivots out of its open position at least regionally into the interior of the housing traversable by air, it releases at least portions of the opening formed on the housing wall. It is then in an intermediate position, in an extreme case in the closed position.

In this regard, another exemplary embodiment provides that the at least one flap at least regionally project into an interior of the housing traversable by air in an intermediate or closed position, so as to release the opening of the housing wall. The flap here acts to taper the flow cross section of the housing exposable to air, as a result of which the flow characteristics of the air exiting via the outlet surface can be specifically altered, in one example, spatially bundled.

In another exemplary embodiment, it is here further provided that the flap be pivoted to an edge of the opening in the housing wall facing away from the outlet surface of the housing. In this way, the flap can further be made to assume an air guiding function, and act as a kind of air baffle. Because it is pivoted in the region of the housing wall, the free end of the at least one flap facing away from the pivoting axis can point both into the housing interior and in the direction of flow.

Generally, the entire length of the pivoting axis of the flap extends in the housing wall. In its open position integrated into the housing wall, the flap hence exerts nearly no effect, and does not notably impair or alter the stream of air passing through the air outlet device.

In another exemplary embodiment, the flap is designed to seal the internal cross section of the housing in its closed position. In this regard, the flap can regulate not just the flow characteristics and spatial expansion of the supplied air stream, but also the amount of air flowing via the outlet surface. The flap is here adjusted to the geometry of the housing interior in such a way as to seal off the entire internal cross section of the housing in the closed position.

Another exemplary embodiment provides for at least two flaps arranged on mutually opposing housing walls, which are each integrated into the opposing housing walls of the housing in the open position, but extend into the housing interior in their intermediate or closed position, so as to specifically alter the amount of air and/or flow characteristics of the air stream.

It is here provided in one example, that the free ends of the flaps extending into the interior of the housing can be made to abut each other and form a seal in the closed position. The free ends of the flaps here generally come to abut each other at roughly the midpoint between the opposing housing walls of the housing, so that moving the flaps leads to a significant change in only the flow rate and spatial expansion of the flow, but not in the direction of flow.

In another exemplary embodiment, the at least one flap can also exhibit a beak-like free end, which in the closed position of the flap extends substantially parallel to the alignment of the housing wall on which the respective flap is pivoted or which lies opposite the flap. Having the free ends protrude outwardly in a beak-like manner toward the housing wall opening makes it possible to enlarge the mutually abutting surfaces of the flaps that can be contacted with each other to form a seal and an opposing housing wall. An exemplary embodiment with two flaps provides that the free ends of the flaps bent over like beaks can be made to abut so as to form a seal.

While the at least one flap, generally two flaps, extend substantially inclined relative to the air stream or inclined relative to the housing wall in their intermediate or closed position, the free ends of the flaps can be aligned substantially parallel to the direction of air flow. In this respect, the flap arrangement can provide a nozzle-like configuration that tapers in the direction of flow, which facilitates the establishment of a hydrodynamic pressure that holds the flaps together due to the increasing flow rate between the flaps.

In another exemplary embodiment, the flaps are synchronously coupled with each other. In this respect, a mechanical-kinematic actuator is provided for the flaps, which interacts to the same extent with both flaps. For example, the flaps can exhibit at least one toothed wheel in the area of their pivoting axes, which is functionally connected with a manually activatable flap drive. For example, in order to transmit force or torque to the flaps, interconnected toothed racks that mesh with respective toothed wheels of the flap stems can be provided, which on the drive side are directly functionally connected with a user-operable actuator located in the area of the outlet surface.

In another exemplary embodiment, the air outlet device exhibits pivoted and mutually parallel lamellae downstream from the at least one flap, by means of which the direction of flow of the exiting air can be specifically altered. The lamellae are here generally provided in the area of the outlet surface of the air outlet device designed as an air outlet nozzle. In this case, one or more planes of lamellae can be provided, which each are distributed over the entire flow cross section of the air outlet device and coupled with each other so as to be motion-synchronized.

For example, horizontally aligned lamellae can be used to specifically change the height of the air stream, and vertically aligned lamellae to specifically change a direction of the air stream related to the transverse direction of the vehicle. In an intermediate position, the flaps situated upstream from the air outlet lamellae in the direction of flow can alter the traversable cross section of the air outlet device housing in such a way that only a central region of the downstream lamellae is exposed to air.

Another exemplary embodiment of the above further provides a ventilator for a motor vehicle, which exhibits at least one air outlet device described above. For example, the ventilator can be designed as a heating, ventilating and air conditioning module, a so-called heating-ventilating-air conditioning (HVAC) module, and exhibit a plurality of flow channels situated downstream from a fan, whose downstream ends are provided with at least one of the air outlet devices described above.

In addition, another exemplary embodiment provides for a motor vehicle, which exhibits a corresponding ventilator, which is furnished with at least one of the air outlet devices described above.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a diagrammatic and perspective view of an exemplary air outlet device,

FIG. 2 is a side view of the flaps provided in the exemplary air outlet device, and

FIG. 3 is a cross section through the exemplary air outlet device according to FIG. 1 along the direction of flow.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

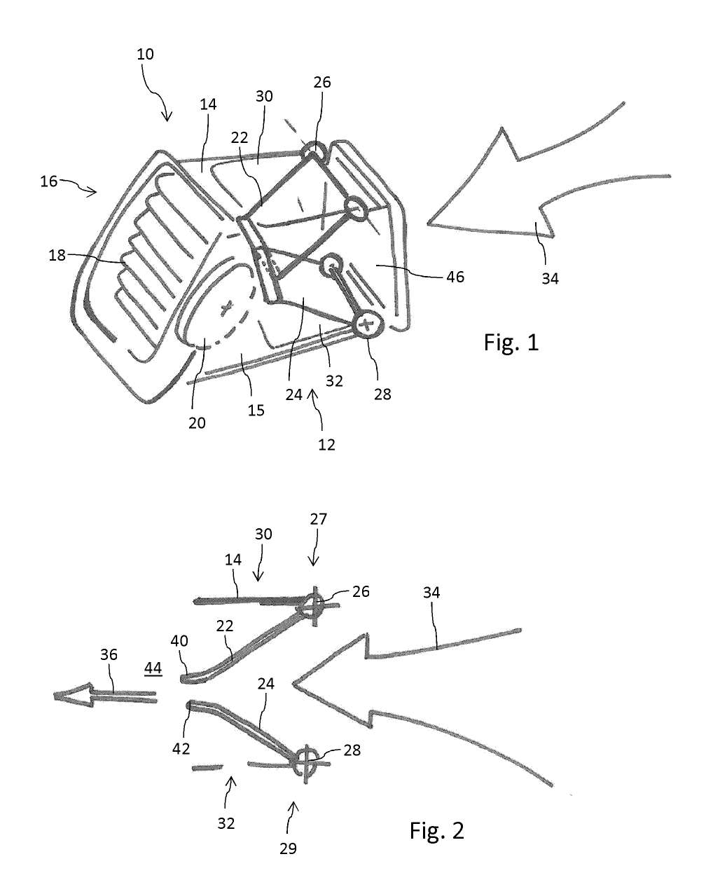

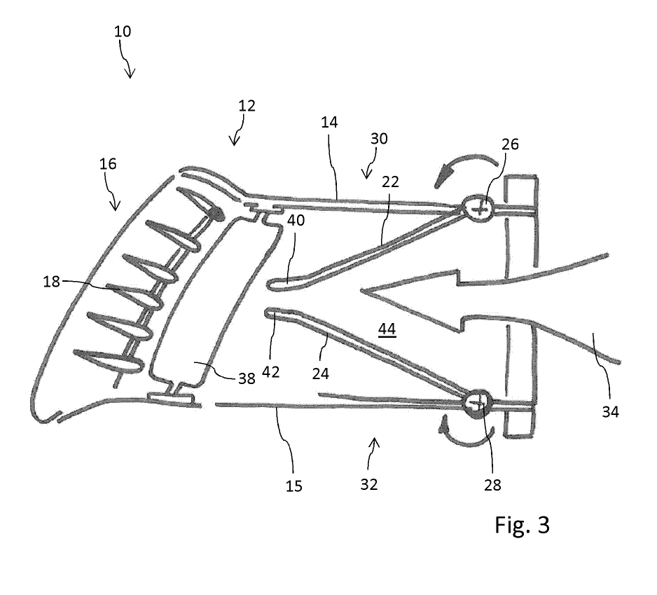

The air outlet device 10 shown on FIGS. 1 to 3 exhibits a housing 12, which has a roughly rectangular internal cross section 46 traversable by supplied air 34. An outlet surface 16 is situated downstream from the air outlet device 10, on the left side on FIGS. 1 and 3, and allows the supplied air 34 to flow into a passenger compartment of a motor vehicle, which is not explicitly shown here.

The region of the outlet surface 16 is provided with a row of horizontally aligned lamellae 18, which are aligned substantially parallel to each other, and can be pivoted synchronously to the alignment of the flow of supplied air 34. Another set of vertically aligned lamellae 38 is placed downstream from the horizontal lamellae 18 in the direction of flow, wherein only one such lamella 38 is depicted on FIG. 3. The substantially vertically aligned lamellae 38 can be moved synchronously with each other in a similar manner as the horizontally aligned lamellae 18, so as to be able to specifically align the air 34 even relative to a horizontal component.

In one exemplary embodiment, the housing 12 exhibits an upper housing wall 14, as well as a lower housing wall 15 opposite it. The upper housing wall 14 incorporates an opening 30 that can be sealed by a flap 22. Accordingly, the lower housing wall 15 also exhibits an opening 32, which can be sealed in a comparable manner by a flap 24 designed symmetrically to the upper flap 22.

The end of the two flaps 22, 24 facing away from the outlet surface 16 is pivoted to the respective housing wall 14, 15 in the area of an axis 26, 28, so that they can be moved from an open or basic position lying flush with the respective housing walls 14, 15 and not explicitly shown on the figures to an intermediate position depicted on FIGS. 1 to 3. In this intermediate position, the flaps 22, 24 extend into the interior 44 of the housing 12, and can in this respect diminish the traversable internal cross section 46 of the housing 12.

The flaps 22, 24 are here pivoted to an edge 27, 29 of the respective opening 30, 32 of the accompanying housing wall 14, 15 that faces away from the outlet surface 16 of the housing 12. As a result, the flaps 22, 24 can provide a nozzle-like, continuous diminution of the internal cross section 46 of the housing 12 relative to the direction of the supplied air 34. The flow of supplied air 45 can hence be correspondingly concentrated in terms of its expansion, or bundled and focused, so that an air flow 36 can be provided downstream from the flaps 22, 24 that exhibits an elevated flow rate by comparison to the supplied air 34 and a lower transversal expansion. The air flow 36 bundled in this respect can be used direct the flow directly at the vehicle passengers.

FIGS. 2 and 3 further reveal a beak-like configuration of the free ends 40, 42 of the flaps 22, 24 facing away from the axes 26, 28. The free ends 40, 42 of the flaps 22, 24 pointing in the direction of flow come to mutually abut each other over a comparatively large surface roughly midway between the housing walls 14, 15 in a closed position (not explicitly shown), making it possible to bring about a sealing effect required for closing off the internal cross section 46 of the housing 12. The free ends 40, 42 of the flaps 22, 24 here extend substantially parallel to the housing walls 14, 15 as they come to mutually abut each other in a closed position.

Because the flaps 22, 24 in the interior 44 of the housing 12 can pivot, they substantially simultaneously release the openings 30, 32 of the housing walls 14, 15. Additional air, for example from the vehicle interior, can enter through these openings 30, 32, and be quasi entrained by the concentrated air flow 36. Designing the flaps 22, 24 as part of the housing wall 14, 15 makes it possible to expose the corresponding openings 30, 32 of the respective housing walls 14, 15 to the ambient air present inside the vehicle, thereby allowing the air outlet device 10 to improve the circulation of air located inside the passenger compartment as a whole.

The flaps 22, 24 can be synchronously coupled together, and in one example, the area of their axes 26, 28 can exhibit a toothed wheel or a comparable slave not explicitly shown here, which can be functionally connected in terms of kinematics with an actuating element, for example one designed as a hand wheel 20. The hand wheel 20 makes it possible to substantially synchronously swivel the flaps 22, 24 between an open position, in which the flaps 22, 24 lie substantially flush in the housing walls 14, 15, and a closed position, in which the free ends 40, 42 of the flaps 22, 24 come to abut each other to substantially form a seal, and also into intermediate positions lying in between.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. An air outlet device for the interior of a motor vehicle, comprising:
a housing that exhibits an outflow surface; and
at least one pivoting flap integrated in a wall of the housing upstream from the outflow surface.

2. The air outlet device according to claim 1, wherein the at least one flap seals an opening formed in the wall of the housing in an open position.

3. The air outlet device according to claim 2, wherein the at least one flap at least regionally extends into an interior of the housing traversable by air in an intermediate or closed position, releasing the opening of the wall of the housing.

4. The air outlet device according to claim 2, wherein the at least one flap is pivoted on an edge of the opening facing away from the outlet surface.

5. The air outlet device according to claim 1, wherein the at least one flap seals an internal cross section of the housing in its closed position.

6. The air outlet device according to claim 1, further comprising at least two flaps arranged on opposing walls of the housing.

7. The air outlet device according to claim 6, wherein the free ends of the at least two flaps extend into the interior of the housing and abut each other to form a seal in the closed position.

8. The air outlet device according claim 1, wherein the at least one flap exhibits a beak-like free end, which in the closed position of the at least one flap extends substantially parallel to the wall of the housing.

9. The air outlet device according to claim 6, wherein the at least two flaps are synchronously coupled with each other.

10. The air outlet device according to claim 1, wherein pivoted lamellae arranged parallel to each other are located in the region of the outlet surface.

11. A ventilator for a motor vehicle, comprising:
at least one air outlet device including a housing that exhibits an outflow surface and at least one pivoting flap integrated in a wall of the housing upstream from the outflow surface,
wherein the at least one flap seals an opening formed in the wall of the housing in an open position.

12. The ventilator according to claim 11, wherein the at least one flap at least regionally extends into an interior of the housing traversable by air in an intermediate or closed position, releasing the opening of the wall of the housing.

13. The ventilator according to claim 11, wherein the at least one flap is pivoted on an edge of the opening facing away from the outlet surface.

14. The ventilator according to claim 11, wherein the at least one flap seals an internal cross section of the housing in its closed position.

15. The ventilator according to claim 11, further comprising at least two flaps arranged on opposing walls of the housing.

16. The ventilator according to claim 15, wherein the at least two flaps are synchronously coupled with each other.

17. A motor vehicle, comprising:
a ventilator; and
at least one air outlet device coupled to the ventilator, the at least one air outlet device including at least one air outlet device including a housing that exhibits an outflow surface and at least one pivoting flap integrated in a wall of the housing upstream from the outflow surface,
wherein the at least one flap seals an internal cross section of the housing in its closed position.

18. The motor vehicle according to claim 17, wherein the at least one flap seals an opening formed in the wall of the housing in an open position.

19. The motor vehicle according to claim 18, wherein the at least one flap at least regionally extends into an interior of the housing traversable by air in an intermediate or closed position, releasing the opening of the wall of the housing.

20. The motor vehicle according to claim 18, wherein the at least one flap is pivoted on an edge of the opening facing away from the outlet surface.
